(19) United States
(12) Patent Application Publication
(10) Pub. No.: US 2017/0346935 A1
(43) Pub. Date: Nov. 30, 2017

(54) EXPANSION MODULE FOR A PERSONAL MOBILE DEVICE, COMMUNICATION SYSTEM HAVING AN EXPANSION MODULE, AND COMMUNICATION METHOD

(71) Applicant: LESSWIRE GMBH, Berlin (DE)

(72) Inventors: Ralph Meyfarth, Berlin (DE); Rocco Mertsching, Worthsee (DE)

(21) Appl. No.: 15/505,774

(22) PCT Filed: Aug. 24, 2015
(86) PCT No.: PCT/EP2015/069375

§ 371 Date: Aug. 11, 2017

(30) Foreign Application Priority Data
Aug. 22, 2014 (DE) 10 2014 216 796.7

(51) Int. Cl. H04M 1/725; H04B 1/38; H04M 1/02

(52) U.S. Cl. CPC H04M 1/7253; H04M 1/0254; H04B 1/38; H04M 2250/10

(57) ABSTRACT

An expansion module (10) for a personal mobile device (100) with a transceiver (1) which is designed to transmit and receive data (D) by means of a first, in particular real-time-enabled, radio standard (F1), a data interface (2) which is designed to forward data (D) which have been received by the transceiver (1) by means of the first radio standard (F1) to the personal mobile device (100) and/or to forward data (D) which have been received by the personal mobile device (100) by means of a second radio standard (F2), which differs from the first radio standard (F1), to the transceiver (1).

The present invention relates to an expansion module for a personal mobile device, for example a cellphone, Smartphone, tablet or mobile navigation device. The invention further relates to a communication system with an expansion module and a personal mobile device. The invention similarly relates to a method for operating an expansion module.

GPS modules which are connectable via a cable to a cellphone are known from the prior art. GPS modules of this type have both a receiver to receive data by means of a first radio standard (GPS L1 frequency) and a data interface which is designed to forward the data received by the receiver by means of the first radio standard to the cellphone.

The object of the present invention is to provide an improved expansion module.

The object is achieved by an expansion module with a transceiver which is designed to transmit and receive data by means of a first, in particular real-time-enabled, radio standard, and with a data interface which is designed to forward the data received by the transceiver by means of the first radio standard to the personal mobile device and to forward data originating from the personal mobile device to the transceiver and/or is designed to forward data which have been received by the personal mobile device by means of a second radio standard, which differs from the first radio standard, to the transceiver.

The invention includes the realization that a personal mobile device, for example a Smartphone, can be prepared for Car-to-Car (C2C) communication, Car-to-Roadside (C2R) communication, or Car-to-Infrastructure (C2I) communication through the provision of the expansion module according to the invention.

Data are understood here to mean data and data sets which are relevant, in particular, to the aforementioned communication types, i.e., for example, vehicle event data, such as brake pedal actuations, status information relating to an accident or a roadworks, traffic information, etc.

The expansion module may, for example, receive roadworks information by means of the transceiver during a Car-to-Roadside communication and can forward this information via the data interface to a Smartphone for the purpose of display and/or forwarding via a cellphone network. Similarly, driver inputs on the Smartphone, for example relating to an accident situation, can be forwarded during a Car-to-Car communication to a vehicle located nearby. Tailback information, for example, which is downloaded by the Smartphone from a cellphone network can furthermore be forwarded by way of a relay operation to a vehicle located nearby.

The transceiver is preferably designed to transmit and receive data by means of a real-time-enabled radio standard. The first radio standard may have a latency of less than 20 ms, preferably less than 10 ms, more preferably less than 5 ms. It has proven to be advantageous if the first radio standard is a radio standard other than Bluetooth.

The first radio standard preferably operates in a DSRC (dedicated short-range communication) frequency band in the range from 5.855 GHz-5.925 GHz, in particular according to ETSI EN 302 571, ETSI EN 302 663 or IEEE 802.11p. The second radio standard is preferably a mobile radio standard, in particular GSM, GPRS, EDGE, UMTS, HSPA or LTE.

It has proven to be advantageous to design the transceiver in such a way that its output transmit power is limited in operation to 33 dBm (2 watts).

In one preferred design, the expansion module is designed as an attachment module. The expansion module preferably has its own housing with a mechanical interface for the releasable external fixing of the attachment module to the personal mobile device. It has proven to be advantageous if the data interface is routed at least partially via the mechanical interface in order to enable a simple mechanical and communicating connection between the expansion module and the personal mobile device. A power supply of the expansion module can be routed via the mechanical interface.

In a different design, the expansion module is designed as a plug-in module. The expansion module preferably has a mechanical interface for the releasable internal fixing of the expansion module within a housing or at least partially within a housing of a personal mobile device.

Alternatively or additionally, the expansion module may have a radio interface for the communicating connection of the expansion module to a personal mobile device. The radio interface is preferably a WLAN and/or Bluetooth-based radio interface. An expansion module therefore no longer needs to be attached to or in a personal mobile device and may, for example, be placed in a storage compartment.

The expansion module may have an antenna connection for connecting an external antenna which is suitable for transmitting data by means of the first radio standard. If an external antenna is disposed, for example, outside the passenger compartment, a screening effect by the passenger compartment is avoided.

In one particularly preferred design, the expansion module has an on-board voltage connection, for example an on-board voltage connection for a nominal voltage of 12 volts. Alternatively or additionally, the on-board voltage connection may be designed for connection to a 24-volt and/or 48-volt on-board voltage system. The expansion module can thus be used in different motor vehicles.

It has proven to be advantageous if the expansion module is designed to provide a charging current for an allocated personal mobile device. Alternatively or additionally, the expansion module may be designed to be supplied with current via an allocated personal mobile device.

In a further design, particularly in order to upgrade older mobile devices for Car-to-Car communication, the expansion module has a GPS module.

The expansion module preferably has a communication connection to the vehicle's on-board power supply system, in particular to the vehicle bus. It has proven to be advantageous if the expansion module has an interface to the vehicle bus by having e.g. a connection for an OBD connector and is designed, in particular, to communicate with an OBD system of a motor vehicle. A communication can take place via a CAN bus, Flexray or K-line. Thus, for example, a sudden emergency running of a vehicle can be signaled to nearby vehicles during a Car-to-Car communication, thereby increasing road safety. The expansion module may advantageously have a storage unit in which one or more vehicle-manufacturer-specific CAN communication matrices are stored. Further vehicle data, for example a brake pedal actuation, can therefore also be signaled to nearby vehicles during a Car-to-Car communication.

In a further design, the expansion module has a storage unit in which an expansion module ID is stored for the unique identification of a vehicle in which the expansion module is operated.

The expansion module may be designed in such a way that it is connectable via Bluetooth to a personal mobile device. In this case, the expansion module can communicate via two radio standards which differ from one another: on the one hand by means of the first radio standard with a different vehicle during a Car-to-Car communication, on the other hand by means of Bluetooth with the personal mobile device.

In one particularly preferred design, the expansion module is designed to set up a direct communicating connection via the first radio standard to one or more further expansion modules. Thus, for example, a real-time-enabled ad-hoc network can be set up between vehicles. The expansion module is preferably to act as a switch between at least two other expansion modules. A first and second expansion module which are located so far apart from one another that they can no longer communicate directly with one another via the first radio standard for range-related reasons can thus communicate via a third expansion module acting as a switch which is located within communicating range of both the first and the second expansion module.

In terms of the communication system, the object is achieved by a previously described expansion module and a personal mobile device which is allocated to the expansion module. The communication system is preferably designed according to the previously described designs with regard to the expansion module.

In terms of the method, the object is achieved by the method steps of the reception of data by the transceiver via a first, in particular real-time-enabled, radio standard and of the forwarding of the data received via the first radio standard via the data interface to the personal mobile device.

In a further, in particular subsequent, step, the data received via the first radio standard and forwarded to the personal mobile device are transmitted by the personal mobile device via a second radio standard, wherein the first radio standard and the second radio standard differ from one another.

In one preferred design, the method provides a reception of data via the second radio standard by the personal mobile radio device. The data which have been received via the second radio standard by the personal mobile radio device can be forwarded to the transceiver by the data interface.

It has proven to be advantageous to transmit the data received by the data interface by means of the first radio standard by the transceiver, wherein the first radio standard in the second radio standard differ from one another.

In one preferred design, the data received via the first radio standard and forwarded to the personal mobile device are transmitted in a further step by the expansion module connected to the personal mobile device to a different expansion module via the first radio standard.

The method according to the invention may have method steps which correspond to the device features explained in relation to the expansion module, and vice versa. Thus, for example, if the expansion module has been described as having a data interface which is designed to forward data which have been received by the personal mobile device by means of a second radio standard, which differs from the first radio standard, to the transceiver, the following method step is similarly disclosed: forwarding to the transceiver of data which have been received by the personal mobile device by means of a second radio standard which differs from the first radio standard. The same applies to the radio standards disclosed above.

Example embodiments of the invention will now be explained below with reference to the drawings. Further advantages, features and details of the invention can be found in the following description of the preferred example embodiments and with reference to the drawings, in which:

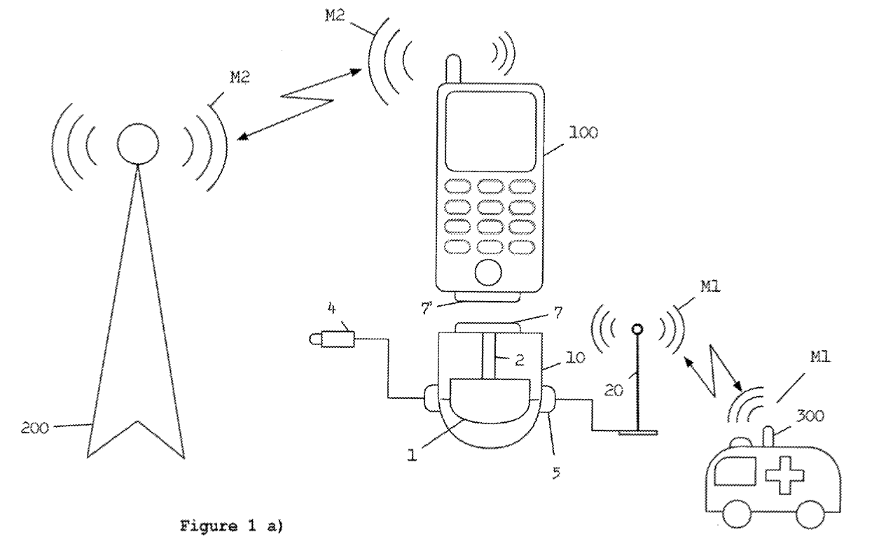

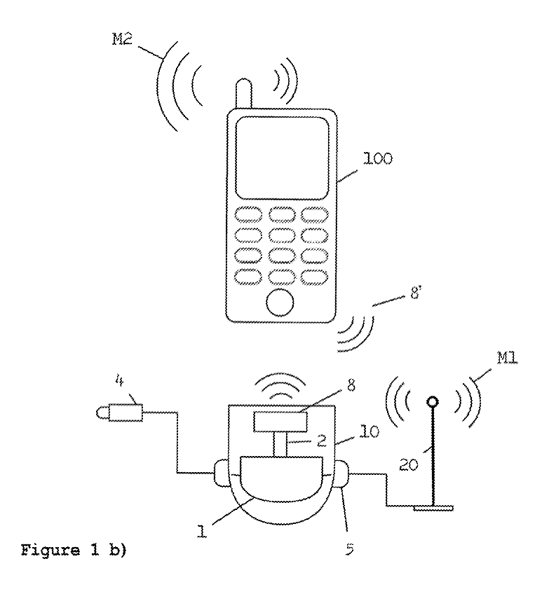

FIG. 1a) shows a schematic representation of a preferred embodiment of an expansion module;

FIG. 1b) shows a schematic representation of a further preferred embodiment of an expansion module;

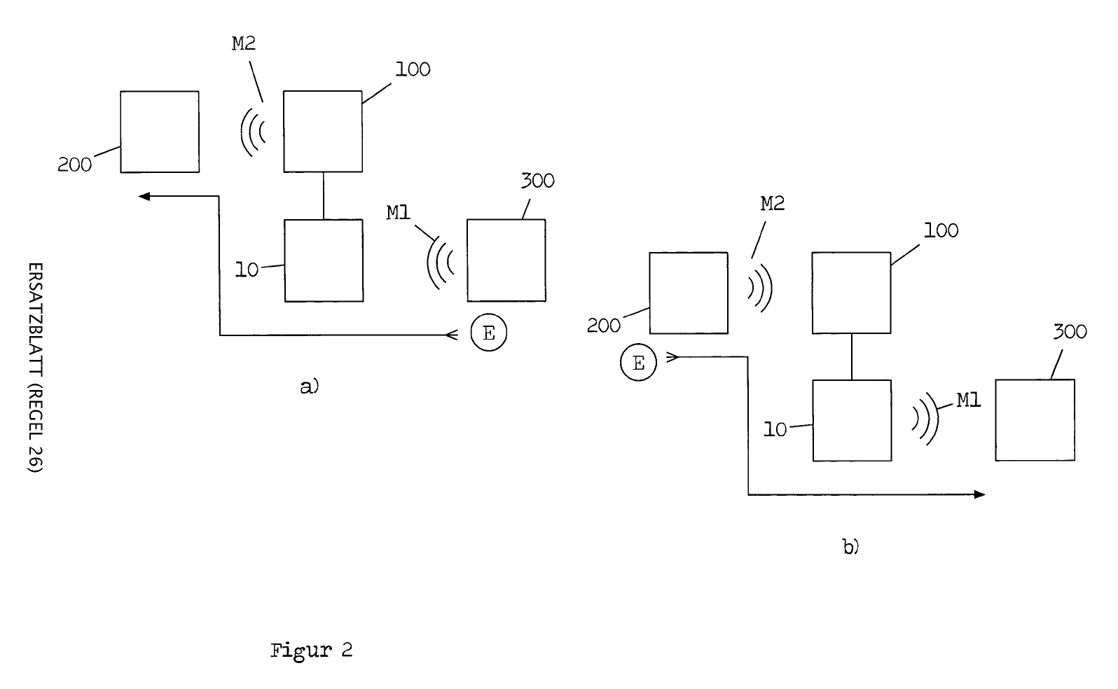

FIG. 2 shows a schematic representation of a preferred embodiment of two methods for operating a communication system consisting of an expansion module and a personal mobile device.

An expansion module 10 for a personal mobile device 100 in FIG. 1a) has a transceiver 1 which is disposed inside a housing of the expansion module. The transceiver 1 is designed to transmit and receive data by means of a first real-time-enabled radio standard F1, which in this case is the introductory standard according to ETSI EN 302 571. The expansion module 10 furthermore has a data interface 2 which is designed to forward data which have been received by the transceiver 1 by means of the first radio standard to the personal mobile device 100. The data interface 2 is similarly designed to forward data originating from the personal mobile radio device 100, i.e., for example, a user input of a driver relating to an accident, to the transceiver 1. It is furthermore provided that the data interface 2 forwards data D which have been received by the personal mobile device 100 by means of a second radio standard F2, in this case the UMTS standard, which differs from the first radio standard F1, to the transceiver 1.

The expansion module 10 is designed here as an attachment module. For this purpose, the expansion module 10 has a mechanical interface 7 which is designed to be accommodated in a releasable manner on a corresponding mechanical interface 7′ of the personal mobile device 100, which in this case is a cellphone.

The data interface 2 is routed here via the mechanical interface 7 out of the housing of the expansion module 10 so that, if the expansion module 10 is connected to the personal mobile device 100, both a mechanical and a communicating connection are set up between the expansion module 10 and the personal mobile device 100.

It is similarly possible for the connection between the expansion module 10 and the personal mobile device 100 to be designed as a radio interface, e.g. WLAN or Bluetooth.

As is further evident from FIG. 1 a), the expansion module 10 has an antenna connection 5 which is designed here for the connection of an external antenna 20. The external antenna 20 is suitable for transmitting data via the first radio standard F1. The expansion model 10 furthermore has an on-board voltage connection 4 which is designed here as a motor vehicle connector for a 12 V on-board power supply system. Both the expansion module 10 and the personal mobile device 100, if it is connected to the expansion module 10, are supplied with current via this on-board voltage connection 4.

In FIG. 1a), the expansion module 10 and the personal mobile device 100 are shown in a typical, in this case schematically represented, Car-to-Car configuration. The personal mobile device 100 has a communication connection to a mobile radio transmission mast 200. This is represented by the radiated waves of a second radio standard F2, in this case UMTS. Here, the communication connection via the second radio standard F2 is not real-time-enabled, i.e. the information to be transmitted between the mobile radio transmission mast 200 and the personal mobile radio device 100 is subject to a certain latency.

A data communication connection to the personal mobile device 100 is now enabled via the expansion module 10 by means of a first, in this case real-time-enabled, radio standard F1. As shown in FIG. 1a), a radiocommunication connection is set up between the expansion module 10 and a vehicle 300, in this case an ambulance.

Here, the vehicle 300 is located within a radius of less than 1000 m from the expansion module 10. The vehicle 300 transmits a data set, containing both position data and status data of the vehicle 300, via the radiocommunication connection of the first radio standard F1 in real time to the expansion module 10. The status data are preferably standardized CAM/DEMN messages according to the ETSI ITS G5 standard and/or standardized WSMP messages according to the IEEE 1609.3 standard. On the one hand, the data to be transmitted are then presented on a display of the personal mobile radio device 100. The data originating from the vehicle 300 are furthermore transmitted via the mobile device 100 itself by means of the second radio standard F2 to the mobile radio transmission mast 200 and from there to a traffic server. Vehicles which are located at a greater distance, i.e., for example, 20 km behind the ambulance, can in turn be informed of its position and status via the traffic server and the mobile radio mast 200.

An expansion module 10 for a personal mobile device 100 in FIG. 1b) corresponds to the expansion module described in relation to FIG. 1a) with the difference that a connection between the expansion module 10 and the personal mobile device 100 is established via a radio interface 8, in this case designed as a Bluetooth interface. The personal mobile device 100 has a corresponding Bluetooth interface 8′.

Preferred embodiments of two communication methods will now be described more precisely with reference to FIG. 2.

FIG. 2a) initially shows schematically a personal mobile device 100 which is connected to an expansion module 10. FIG. 2a) further shows a mobile radio mast 200 and a vehicle 300. Here, the arrow denoted by D indicates the path of vehicle data of the vehicle 300 in the described method. In a first step S1, data D are received by the transceiver (not shown) of the expansion module 10 via a first real-time-enabled radio standard F1. In a second step S2, the data received via the first radio standard are forwarded via the data interface to the personal mobile device 100. In a third step S3, the data received via the first radio standard F1 and forwarded to the personal mobile device 100 are transmitted by the personal mobile device 100 via a second radio standard F2. Here, the first radio standard F1 is a radio standard which differs from the second radio standard F2. More precisely, the first radio standard F1 is a real-time-enabled radio standard according to ETSI EN 302 571 and/or IEEE802.11p, whereas the second radio standard is a non-real-time-enabled radio standard, in this case UMTS.

FIG. 2a) therefore shows accordingly the situation in which information is fed from a vehicle 300 via the expansion module 10 and the personal mobile device 100 into a mobile radio network via a mobile radio mast 200.

FIG. 2b) similarly shows these components that have just been described, i.e. the expansion module 10, the personal mobile radio device 100 and the mobile radio mast 200, and also the vehicle 300. FIG. 2b) now shows how a dataset D which is received via a mobile radio mast 200 by the mobile device 100 via the second radio standard F2 is forwarded to a vehicle 300.

In a fourth step S4, data are received by the personal mobile radio device 100 via the second radio standard. Here, these are data relating to a roadworks in the context of a Car-to-Infrastructure communication, i.e. at a greater distance along the route, in the context of a Car-to-Infrastructure communication. In a further step S5, the data which have been received by the personal mobile radio device 100 via the second radio standard F2 are forwarded to the transceiver (not shown) by the data interface in order to be forwarded in real time in a step S6 by means of the first radio standard F1 to the vehicle 300. As in the example described with reference to FIG. 2a) also, the first radio standard F1 and the second radio standard F2 differ from one another.

1. An expansion module for a personal mobile device comprising:
a transceiver configured to transmit and receive data by a first radio standard, wherein the first radio standard is real-time-enabled,
a data interface configured to forward data which have been received by the transceiver by the first radio standard to the personal mobile device and to forward data originating from the personal mobile device to the transceiver ,
and
configured to forward data which have been received by the personal mobile device by a second radio standard, which differs from the first radio standard, to the transceiver, wherein the second radio standard is a mobile radio standard.

2. The expansion module as claimed in claim 1, wherein the first radio standard is a radio standard according to ETSI EN 302 571, ETSI EN 302 663 or IEEE 802.11p.

3. The expansion module as claimed in claim 1, wherein the expansion module is configured as an attachment module or plug-in module.

4. The expansion module as claimed in claim 1, wherein the expansion module has an antenna connection for the connection of an external antenna which is suitable for transmitting data by the first radio standard.

5. The expansion module as claimed in claim 1, wherein the expansion module has an on-board voltage connection.

6. The expansion module as claimed in claim 1, wherein the expansion module has a GPS module.

7. The expansion module as claimed in claim 1, wherein the expansion module has a communicating connection to a vehicle's on-board power supply system.

8. The expansion module as claimed in claim 1, wherein the expansion module has a connection for an OBD connector.

9. The expansion module as claimed in claim 1, wherein the expansion module has a storage unit in which an expansion module ID is stored.

10. The expansion module as claimed in claim 1, wherein the expansion module is connectable via Bluetooth to a personal mobile device.

11. A communication system comprising an expansion module as claimed in claim 1 and a personal mobile device.

12. A communication method for operating an expansion module as claimed in claim 1 comprising:
receiving data by the transceiver via the first radio standard, wherein the first radio standard is real-time-enabled,
forwarding the data received via the first radio standard via the data interface to the personal mobile device, and
transmitting the data received via the first radio standard and forwarding to the personal mobile device by the personal mobile device via the second radio standard, wherein the first radio standard and the second radio standard differ from one another and the second radio standard is a mobile radio standard.

13. The method as claimed in claim 12, further comprising:
receiving data via the second radio standard by the personal mobile radio device,
forwarding the data which have been received via the second radio standard by the personal mobile radio device to the transceiver by the data interface, and
transmitting the data received by the data interface by the first radio standard by the transceiver, wherein the first radio standard and the second radio standard differ from one another.

14. A communication method for operating a communication system as claimed in claim 11, comprising:
receiving data by the transceiver via the first radio standard, wherein the first radio standard is real-time-enabled,
forwarding the data received via the first radio standard via the data interface to the personal mobile device, and
transmitting the data received via the first radio standard and forwarding to the personal mobile device by the personal mobile device via the second radio standard, wherein the first radio standard and the second radio standard differ from one another and the second radio standard is a mobile radio standard.

15. The method as claimed in claim 14, further comprising:
receiving data via the second radio standard by the personal mobile radio device,
forwarding the data which have been received via the second radio standard by the personal mobile radio device to the transceiver by the data interface, and
transmitting the data received by the data interface by the first radio standard by the transceiver, wherein the first radio standard and the second radio standard differ from one another.
